(19) United States
(12) Patent Application Publication
(10) Pub. No.: US 2009/0200821 A1
(43) Pub. Date: Aug. 13, 2009

(54) PART MOUNTED ON AUTOMOTIVE COMPARTMENT CEILING

(75) Inventor: Takatugu NAGATA, Toyota-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: KOJIMA PRESS INDUSTRY CO., LTD., Toyota-shi (JP)

(21) Appl. No.: 12/143,365

(22) Filed: Jun. 20, 2008

(30) Foreign Application Priority Data
Feb. 7, 2008 (JP) 2008-027684

(51) Int. Cl. B60R 27/00

(52) U.S. Cl. 296/24.34; 296/37.7

(57) ABSTRACT

A part mounted on the compartment ceiling of an automotive vehicle which has a casing with burglar alarm sensor and substrate for the lighting equipment assembled therein, wherein the casing is formed of a resin material containing at least one of azadirachtin, meliantriol and salanin, which are insect repellent components contained in triperten, a natural organic compound, so as to prevent insects from intruding through gap P between panel and intrusion sensor of the casing or gap Q between cover and light source, thereby avoiding unattractive looking lens unit, and preventing a fault such as an electric short of substrate which otherwise might be caused by an insect coming into contact with the part.

### TECHNICAL FIELD

This invention relates to a part mounted on the ceiling of an automotive vehicle compartment in which an electric part such as a burglar alarm sensor or light is assembled on a casing, or specifically to a part mounted on an automotive vehicle compartment ceiling and having a means for preventing the intrusion of insects into the casing.

### BACKGROUND ART

In the prior art, insects may intrude into the ceiling from the left and right columns of the vehicle or the “sun roof” which may be opened/closed, resulting in insects intruding from the back (ceiling side) of an overhead console arranged on the ceiling and coming into contact with the substrate or the like, often causing an electric short. An insect that has intruded into the lens of the light is visible from the compartment, which makes an overhead console look unattractive from a design viewpoint.

An example of the configuration of a conventional overhead console is shown in FIGS. 5A to 7. Cover 1′, burglar alarm sensor 2′, substrate 4′ and small-item box 7′ are fixedly screwed to panel 3′, while lens 6′ is fixed to on panel 3′ by claws. Further, light source 6′ of an indoor light is fixed to on substrate 4′. An overhead console configured as above is used for many purposes, for example, as an accommodation space for a light or a burglar alarm sensor and a small-item box for eyeglasses or the like.

However a conventional overhead console has the disadvantages described below. Specifically, cover 1′ attached to the back of the overhead console cannot prevent intrusion of insects. An insect which has intruded into the lens unit (the space between substrate 4′ and lens 6′ in FIGS. 6 and 7) is visible from the inside of the compartment.

Insects intrude due to a large gap (portion P′ in FIGS. 6 and 7) formed between intrusion sensor 2′ and panel 3′, from which insects easily find their way into the overhead console. The intrusion of insects from the gap of portion P′ often causes a trouble such as a malfunction of intrusion sensor 2′.

Insects may also intrude because substrate 4′ has an opening such as a radiator for light source 5′, and gap Q′ thereof allows insects to reach the lens unit. As a result, an overhead console looks unattractive or the insect may come into contact substrate 4′ sometimes causing a short in the electrical system. Although only one example of a conventional overhead console configuration is described above, many conventional overhead consoles have a similar gap in portion P′ or Q′. Therefore, preventing intrusion of an insect becomes a problem.

An insect repellent device for automotive vehicles is described in Japanese Unexamined Patent Publication No. 2005-153631, and Japanese Unexamined Patent Publications Nos. 5-246801 and 2006-325564. Eugene B. Shultz “Neem Tree Saves the Earth (sic)”, National Research Council, abridged translation by “Kankyo Nougyou Shimbun (Environmental Agriculture News)”, Jan. 15 and Mar. 15, 2005, contains a description of plants having an insect repellent component.

However the insect repellent device described in Japanese Unexamined Patent Publication No. 2005-153631, is complicated and requires a large number of parts. The inventions of materials having insect repellency described in Japanese Unexamined Patent Publications Nos. 5-246801 and 2006-325564 have a different configuration from the present invention.

### DISCLOSURE OF THE INVENTION

The object of this invention is to solve the problem described above and provide a part mounted on an automotive compartment ceiling which prevents insects from intruding into a casing thereby avoiding an unattractive lens unit and preventing a functional fault.

In order to solve the problem described above, the present invention provides a part mounted on an automotive compartment ceiling with an electrical part assembled in a casing, characterized by an insect repellent means for preventing insects from intruding into the casing. As a result, the intrusion of insects into the casing can be prevented and an electric short which otherwise might be caused by an insect coming into contact the substrate can be avoided.

Preferably the casing is formed of a resin material which is obtained by mixing the resin material and a component having insect repellency. Herewith, the approach of insects to the casing is blocked thereby preventing an inconvenience.

Preferably the component having the insect repellency is at least one of azadirachtin, meliantriol and salanin which are contained in triperten, a natural organic compound. Thus, the part contains a compound of the neem tree which has an insect repellency, thereby preventing insects from intruding into the casing.

Preferably the casing is configured of a compartment-side member and a ceiling-side member, furthermore, the ceiling-side member contains any of the components described above. The ceiling-side member is located on the back of the casing. Therefore, there is no need to worry about color irregularities or the like, which might be caused by mixing the above-mentioned components in forming the member.

Preferably the insect repellent component is sprayed on the casing, the part mounted on the automotive compartment ceiling and having the insect-repellence effect can be provided by a simpler method.

As explained above, according to this invention, a part is provided which is mounted on an automotive compartment ceiling, which can avoid horrible looking of the lens unit and prevent insects from intruding into the overhead console.

### BRIEF DESCRIPTION OF THE DRAWINGS

FIG. 1A is a rear view of the overhead console according to an embodiment of this invention.

FIG. 1B is a side view of the overhead console according to an embodiment.

FIG. 1C is a front view of the overhead console according to an embodiment.

FIG. 2 is a sectional view taken in line I-I in FIG. 1A.

FIG. 3 is a sectional view taken in line II-II in FIG. 1A.

FIG. 4A is a front view of the cover of the overhead console according to an embodiment.

FIG. 4B is a right side view of the cover of the overhead console according to an embodiment.

FIG. 5A is a rear view of the conventional overhead console.

FIG. 5B is a side view of the conventional overhead console.

FIG. 5C is a front view of the conventional overhead console.

FIG. 6 is a sectional view taken in line III-III in FIG. 5A.

FIG. 7 is a sectional view taken in line IV-IV in FIG. 5A.

### BEST MODE FOR CARRYING OUT THE INVENTION

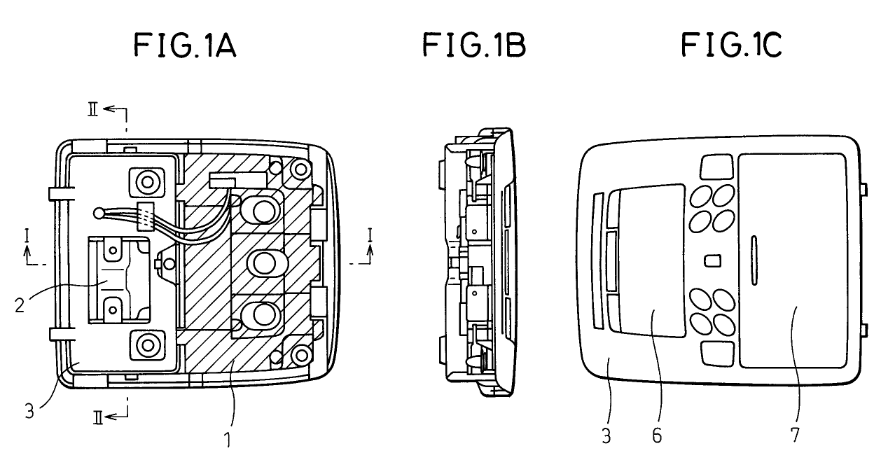

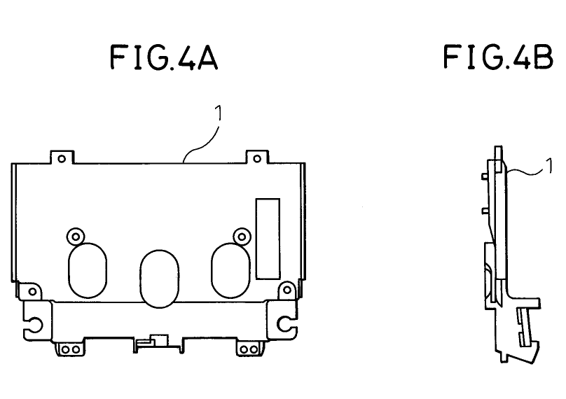

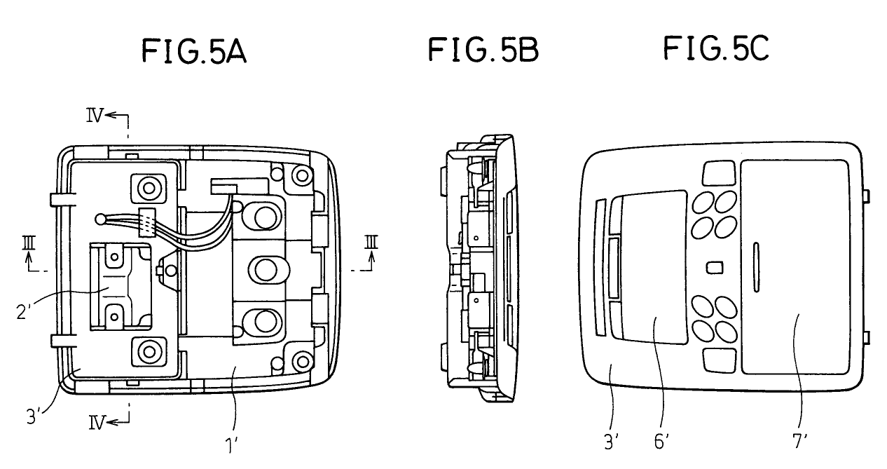

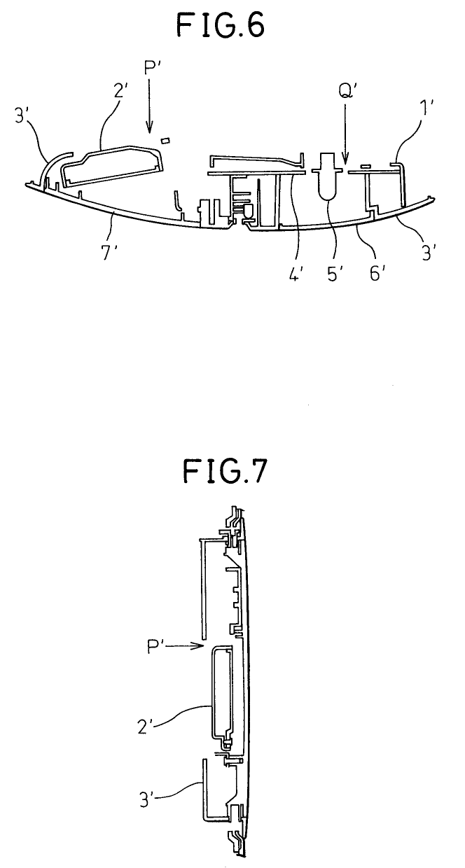

The embodiments of the invention are explained below with reference to FIGS. 1A to 4B.

A preferred embodiment of the casing of the overhead console is configured of resin panel 3 and cover 1. Panel 3 covers the entire front (compartment-side), except a portion of lens 6 and small-item box 7 thereon, and a part of a back (ceiling-side) surface. Cover 1 is arranged only on the back surface.

Cover 1, intrusion sensor 2, substrate 4 and small-item box 7 are fixedly screwed to the panel 3, and lens 6 is fixed to on panel 3 with claws. Further, light source of an indoor lamp is fixed to substrate 4.

Portion P forms a gap around panel 3 and intrusion sensor 2 so as to make easy to mount intrusion sensor 2 on panel 3. Portion Q, on the other hand, forms a radiation hole of substrate 4 to radiate heat from light source 5.

According to a first embodiment, the entire casing of the overhead console including resin panel 3 and cover 1 is formed of resin mixed with an insect repellent component to prevent insects from intruding into the overhead console.

Specifically, panel 3 and cover 1, made of resin are formed by mixing one or a plurality of insect repellent components including azadirachtin, meliantriol and salanin which are contained in triperten, a natural organic compound contained in the neem plant.

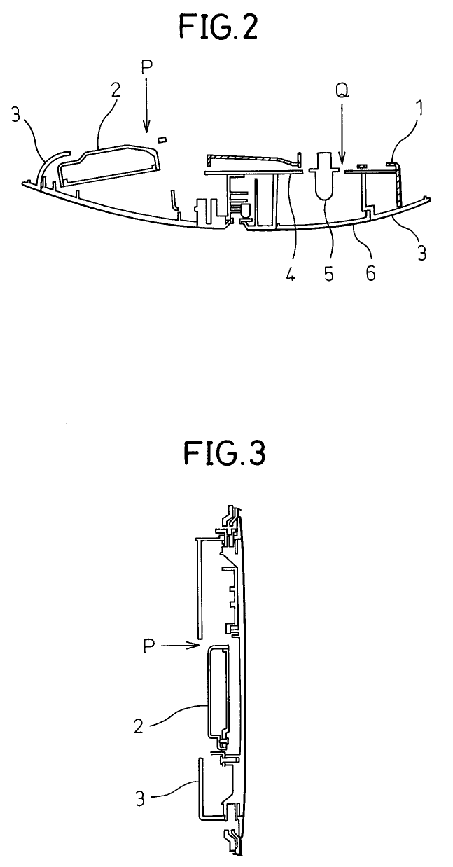

These resin parts are insect repellent, therefore, insects are prevented from intruding into the lens unit (the space between substrate 4 and lens 6 in FIG. 2) by way of portion Q, thereby making it possible to avoid an unattractive lens unit, and to prevent electrical system problems such as a short, which otherwise might be caused by an insect coming into contact with substrate 4.

Insects are also prevented from intruding by way of portion P, and a malfunction of intrusion sensor 2, which may be caused by the intruding insects is prevented.

According to a second embodiment, the resin mixed with any of the aforementioned components of triperten is used only for cover 1 which is not a component of design of the overhead console casing, while panel 3 is formed of the conventional resin.

In the case where an insect repellent component is contained in panel 3 including the front decoration surface facing the compartments, color irregularities which may be caused by the molding process. Therefore, to cope with this problem, according to this embodiment, only cover 1 applied to the back surface not constituting a decoration surface contains the insect repellent component.

With the configuration described above, the intrusion of insects into the overhead console can be prevented in the same shape as the conventional overhead console without attaching any special part such as a mosquito net. Thus, cost can be reduced compared with the method which requires a design change, such as the addition of an insect repellent part.

We believe the following may be why an overhead console having the above-mentioned configuration has not been found.

Mainly, it is not generally known to mix chemical insect repellent with a material used as an element of an overhead console, for example resin, not only in the field of automotive parts, but also in other fields, and the insect repellency effect thereof has not been reliable.

Further, the desire to obtain insect repellency has been not so strong, and designers of overhead consoles have been satisfied with the insufficient insect repellency provided by the prior art, for example, an insect net, and have not tried to obtain better insect repellency for an overhead console.

Accordingly, an overhead console using a chemical repellency component mixed with a material used as an element thereof has not been realized.

The present inventors had investigated the insect repellency so as to reduce the number of parts of the overhead console, therefore, they conceived of the aforementioned configuration.

As another embodiment, a material containing an insect repellent component not used for the parts such as the overhead console cover but the insect repellent component may be sprayed on the conventional cover on the back of the decoration surface of the overhead console. In this way, a similar insect repellency can be produced without any design change of the conventional overhead console.

According to still another embodiment, an insect repellent mat (or sponge) may be attached to the back of the decoration surface of the overhead console. The insect repellent mat contains any of the insect repellent components described above. The insect repellent mat is mounted just proximal to gaps P and Q on the back of the decoration surface of the overhead console. In this way, a similar insect repellency can be produced without any considerable overhead console design change.

According to another embodiment, a net-like member processed from the material of the aforementioned mat may be attached on gaps P and Q on the back of the decoration surface of the overhead console. The net-like insect repellent means can produce a similar insect-repellence effect without adversely affecting air flow on the back of the overhead console decoration surface.

1. An automotive compartment ceiling part to which an electric part is assembled in a casing thereof, being arranged on the ceiling of an automotive compartment, characterized by:
an insect repellent means to prevent intrusion of insects into said casing.

2. The automotive compartment ceiling part as set forth in claim 1, characterized in that said casing is formed of a resin material, and said resin material is mixed with an insect repellent component.

3. The automotive compartment ceiling part as set forth in claim 1, characterized in that said insect repellent component is formed of one or a plurality of azadirachtin, meliantriol and salanin which are contained in triperten, a natural organic compound.

4. The automotive compartment ceiling part as set forth in claim 1, characterized in that said casing is configured of a compartment-side member and a ceiling-side member and the latter is mixed with said insect repellent component.

5. The automotive compartment ceiling part as set forth in claim 1, characterized in that said insect repellent components are sprayed on said casing.
